(19) United States
(12) Patent Application Publication
(10) Pub. No.: US 2025/0011143 A1
(43) Pub. Date: Jan. 9, 2025

(54) SEPARATOR ELEMENT SEPARATING ROPE LENGTHS IN A HOIST, HOIST COMPRISING SAID SEPARATOR ELEMENT AND RESPECTIVE METHOD OF USE

(71) Applicant: ALUDESIGN S.P.A., Lecco (LC) (IT)

(72) Inventors: Ugo PEGURRI, Sovere (BG) (IT); Luciano Marlon MAFFINI, Seriate (BG) (IT)

(21) Appl. No.: 18/708,891

(22) PCT Filed: Oct. 21, 2022
(86) PCT No.: PCT/IB2022/060150

§ 371 Date: May 9, 2024

(30) Foreign Application Priority Data
Oct. 22, 2021 (IT) 102021000027200

(51) Int. Cl. B66D 3/08; A62B 1/06; A62B 1/08; A62B 1/18

(52) U.S. Cl. CPC B66D 3/08; A62B 1/18; A62B 1/06; A62B 1/08

(57) ABSTRACT

A separator element is described (1), adapted to be used in a hoist (100) and configured to be interposed between a first element (2) and a second element (3) of said hoist (100) or to be made in one piece with said first element (2) and/or said second element (3), said separator element (1) comprising a main body (10) and at least two seats (S1, S2, S3, S4) for the passage of as many lengths (F1, F2, F3, F4) of a rope (F) of said hoist (100) through said separator element (1).

### FIELD OF THE INVENTION

The present invention relates to a separator element separating rope lengths. More particularly, the present invention relates to a separator element separating rope lengths, which is particularly adapted to be used inside a hoist set up for moving a load.

Furthermore, the present invention relates to a hoist comprising the aforesaid separator element and a respective method for verifying the configuration of the same hoist.

The present invention is mainly used in the field of equipment for professional use in work at height, rescue operations and sport climbing.

### KNOWN PRIOR ART

In the context of work at height and sport climbing, the use of hoists for moving loads, whether people or objects, is known. In particular, hoists are particularly useful in operations of lifting a particularly heavy load or in operations of recovering a person stuck and/or in difficulty at height.

In its essential elements, a hoist consists of two main elements, each comprising at least one pulley. Typically, one of the two elements is fixed, e.g. connected to an anchoring point by a connector, e.g. a karabiner, while the other is movable and connected, e.g. still by a further connector, to the load to be moved by the same hoist. At the aforesaid pulleys a rope or cord is housed, which makes one or more returns between said fixed element and said movable element of the hoist, preferably remaining housed in special grooves with which the outer profiles of the pulleys are equipped. Said rope is fastened, at one end, to one of the two main elements, typically the fixed element, while the other end is free. This free end is coming out of one of the two main elements, generally the fixed element, such that it can be operated by an operator who can exert a traction force capable of moving the load connected to the movable element.

In the most basic shape of the hoist, also referred to as simple hoist, the rope, fastened to the fixed element at one end, is first passed around a pulley of the movable element and then is returned to the fixed element, of which it comes out with its own free end after having passed around a respective pulley. This free end can be tensioned by an operator to perform load moving manoeuvres.

More advanced versions of the hoist are also known, also referred to as reduction gear hoists, in which the rope is returned multiple times between the fixed element and the movable element. These hoists allow a load to be moved with a favourable ratio of forces, i.e. they allow a load to be moved by exerting less force on the free end than would be required with a simple hoist. As the number of returns that the rope carries out between the fixed element and the movable element increases, the ratio of forces in moving the load becomes more favourable. Necessarily, in reduction gear hoists, the fixed and movable elements must be equipped with a dedicated pulley for each rope return, in order to avoid overlaps and entanglements that could cause malfunctions of the same hoist. For example, hoists are known in which the fixed element and movable element each have two pulleys and the rope carries out two round trips between the aforesaid fixed element and movable element, passing on a different pulley at each turn. In other words, the hoist consists of four lengths of the same rope that engages four pulleys, two for the fixed element and two for the movable element. With this type of hoist, known as a 4:1 hoist, the force to be exerted to move the load is four times lower than that force required to move the load without hoist.

In spite of the obvious advantages linked to the reduction in the efforts required, reduction gear hoists have certain problems linked to the presence of numerous rope lengths in the gap between the movable element and fixed element.

In fact, it is frequent that, during the transport and set-up of the hoist to operating position, the rope returns become entangled or loose rope branches are inserted between the aforesaid returns, tangling the same hoist and making it difficult to manoeuvre, if not downright dangerous due to the risk of jamming once in operation. These tangles are particularly complicated to untangle and the user can take rather long periods of time to restore the hoist to its optimal operating condition. Such wastes of time are to be avoided especially in recovery and rescue operations, where the timeliness of intervention is critical.

To overcome these drawbacks, some manufacturers have produced solutions in which the rope lengths are contained inside a protection element, such as a sheath or sleeve, configured to prevent loose rope branches from becoming tangled with each other.

In this regard, see document U.S. Pat. No. 9,617,128 B2 in which a deformable containing element is placed in direct contact with the first pulley element and the second pulley element, actually delimiting the gap for passing the rope lengths and preventing the free branches of the same rope from tangling in the hoist with the other rope lengths placed between the two pulleys and with the same pulleys.

However, even these solutions are not free from problems. In fact, during the moving of the load, the containing protection element can be intercepted by the rope branches and slip into one or more pulleys, worsening their friction or even blocking them. Furthermore, when the movable and fixed elements are particularly close to each other, the containing protection element is particularly compacted to the point of acting as a spring, thus hindering the correct operation of the same hoist, e.g. by making it difficult or impossible to loosen or release the locking element, typically in the form of a toothed cam, which selectively locks/brakes the last rope branch coming out of the hoist.

In addition, it is noted that, during the use of the hoist, the space inside the containing protection element is inaccessible from the outside. If a tangle were to occur between the rope lengths contained therein, e.g. due to a wrong set-up of the hoist's returns, it would be difficult to take action to restore the correct position of the rope lengths.

Object of the present invention is therefore to solve the above-mentioned drawbacks of the known art. In particular, it is an object of the present invention to provide a separator element of rope lengths in a hoist that is reliable both during the set-up and during the use of the same hoist.

Further object of the present invention is to provide a separator element that is particularly simple and economical to produce, as well as easy to install and use.

Another object of the present invention is to provide a hoist comprising the aforesaid separator element that is particularly reliable and does not expose the load being moved to risks to its safety, due to the undesired presence or formation of entanglements between rope lengths and respective pulleys.

Yet another object of the present invention is to provide a method for verifying the configuration of the hoist and possibly restoring the same hoist, comprising the aforesaid separator element, which is particularly simple to implement and that ensures safety during the actual use of the hoist in load moving operations.

### SUMMARY OF THE INVENTION

These and further objects are achieved by the present invention thanks to a separator element adapted to be used in a hoist according to claim 1, a hoist comprising said separator element according to claim 12 and a method for verifying the status of the correct configuration of said hoist according to claim 17. Further preferred characteristics and aspects of the invention are described hereinafter and/or presented in the dependent claims.

According to a first aspect, the present invention relates to a separator element adapted to be used in a hoist, e.g. interposed between at least one first hoist element and at least one second hoist element or made of a single piece (in one piece) with at least one hoist element. Said separator element is adapted to be indifferently used in hoists of the simple type or in reduction gear hoists.

Said separator element is configured to be interposed between a first element and a second element of said hoist or to be made in one piece with said first element and/or said second element. The configuration and shape of said first and second hoist elements, e.g. comprising at least one pulley, will be described below in the present description.

In an embodiment, said separator element is movably interposed between said first and second elements of the hoist, i.e. it can translate in the gap between said elements, in particular by sliding along a direction which joins the aforesaid first and second elements which, in use, coincides with the extension of the rope lengths of the aforesaid hoist.

In another embodiment, the separator element is made in one piece with said first element and/or said second element, i.e. the separator element constitutes a part of said first element and/or said second element of the hoist. Equivalently, said separator element may be permanently constrained to said first element and/or said second element and therefore such as not to be movable or separable from said first element and/or said second element.

According to an aspect, said separator element comprises a main body, i.e. a portion constituting the main part of said separator element.

In accordance with the present invention, said separator element comprises at least two seats, which are preferably at least partially defined by said main body, for passing as many lengths of a rope of said hoist through the same separator element. In other words, according to an aspect, said at least two seats are cavities whose contours at least partially coincide with said main body and which pass through said separator element, by placing two substantially opposite sides of the same separator element in communication.

Advantageously, the presence of said seats adapted to house the rope lengths of a hoist allows an orderly set-up of the hoist, while keeping the rope lengths separate, i.e. the rope returns between said first element and said second element. Still advantageously, since the separator element is also movable between said first element and said second element, by sliding the same separator element along the rope lengths, it is possible to identify tangles between the same rope lengths or the insertion of loose rope ends that could cause malfunctions of the hoist.

In particular, said at least two seats extend through said separator element in a rectilinear direction which is substantially parallel to or coinciding with the direction of extension of the rope lengths when the hoist is subjected to tension, e.g. when it is connected to a load to be moved and/or said rope is tensioned by a user.

According to another aspect of the present invention, said at least two seats extend in an extension plane of said separator element and are configured for a passage of said rope lengths in a direction substantially perpendicular to said extension plane. Conveniently, said seats have, along said extension plane, an extension greater than the rope section along the same plane, preferably higher than 125% of the rope section (i.e. the rope occupies at most ⅘ of the extension of the seat in the extension plane).

In the present document, with reference to a three-dimensional object such as the separator element, the term “extension plane” means the extension plane of said element which coincides with a plane orthogonal to a line joining said first and second elements of the hoist, i.e. it means the plane orthogonal to the orientation of the rope lengths of the hoist when the latter is subjected to tension given by the load and/or tensioning of the free end. This plane corresponds with the main extension plane of the separator element in the event that the same separator element has a predominantly planar extension in the aforesaid extension plane.

In that sense, according to an aspect, said at least two seats put in communication sides of the separator element opposite with respect to said extension plane and allow the rope lengths to pass through the separator element in a direction substantially perpendicular to said extension plane. This configuration conveniently allows a practical and immediate use of the separator element in the context of a hoist set up for performing manoeuvres at height.

According to an embodiment, said at least two seats have an open section. In other words, in this embodiment, said seats are not configured as through holes but rather as concavities or bends formed in said separator element, preferably formed in the main body of the separator element.

Preferably, in said embodiment, the separator element comprises a plurality of branches extending from said main body, typically along said extension plane, and defining, together with said main body, said at least two seats for said rope lengths. Specifically, each branch of said plurality of branches is connected to said main body at one end and has the other end free. Said free end of the branch defines, with said main body, an opening in said seat (i.e. the perimeter of the seat is not completely closed but has an opening). This opening put the seat for the passage of the rope in communication with the space outside said separator element also in said extension plane. In particular in said extension plane, said opening has a width lower than the diameter of said rope. Preferably, said width is less than 70% of said diameter of said rope in order to advantageously prevent the rope length housed in said seat from accidentally slipping out once the hoist is set up.

According to an aspect, the branch defining the seat may be temporarily and/or partially deformable, preferably elastically deformable, to allow the insertion of the rope length into the seat. In other words, according to an aspect, the end of the branch is temporarily deformable, e.g. manually by the user, to allow the rope to enter the seat.

According to an aspect, the shape of the branch defining the seat (and, in particular, the shape of the opening in the perimeter of the seat) is chosen in such a way as to facilitate the insertion of the rope length into the seat (e.g. by temporarily crushing the rope) and to prevent it from undesirably slipping out during the operation.

According to another embodiment, said at least two seats have closed section. Preferably, the seats having closed section therefore define through holes in said main body which put opposite sides of said separator element in communication. Advantageously, the presence of through holes in said main body prevents the rope lengths housed therein from slipping out once the hoist is set up.

According to this embodiment, the insertion of the rope into the seats with closed perimeter (holes) takes place when setting up the hoist by passing the end of the rope through the hole.

According to a further aspect of the present invention, said separator element comprises connecting means for preferably reversibly coupling said separator element to one of said first element and said second element of the hoist. Said connecting means are typically positioned at said main body. Depending on the embodiment, said communication means are configured to allow a type of reversible coupling to be chosen from the following: interference, interlocking, shape, snap or other equivalent couplings known in the art.

Advantageously, the presence of connecting means allows to keep said separator element in position during the actual use of the hoist and during the moving of the load connected thereto, while ensuring that the separator element can only slide along said rope lengths during the operations of verifying the correct configuration of the same hoist.

In an embodiment, said connecting means comprise a slot. Said slot is configured to at least partially accommodate one of said first and second elements of said hoist. Specifically, the slot is configured to make a reversible coupling by interference of parts with said first element or second element (preferably with a coupling portion of said first element or second element) which, once at least partially inserted into said slot, remains firmly connected to the separator element. This coupling can only be released by a user applying a sufficient force to extract the portion of the first/second element, which portion is inserted into the aforesaid slot.

According to a particular embodiment, said separator element comprises four seats for the passage of four lengths of said hoist rope. In this embodiment, the hoist within which the separator element is used is a hoist in which the safety rope is returned four times between said first and second elements.

In an embodiment, said separator element is made of plastic material.

In another embodiment, said separator element is made of metal material, such as e.g. steel, having simultaneously high mechanical properties and low weight.

Advantageously, the shape and material of which the separator element is composed make it particularly easy and economical to produce with classic industrial methods, such as moulding.

Further object of the present invention is a hoist for moving a load, comprising the following elements:
a first element comprising at least one first pulley;
a second element comprising at least one second pulley;
the separator element subject matter of the present invention, in accordance with one or more of the aspects/characteristics described above and/or claimed;
a rope, constrained at one end to said first element or said second element, passing through said at least one first pulley and at least one second pulley to define a length at each passage between said first and second elements; said rope further comprises a free end coming out of said first element or second element, which is configured to be operated by a user for moving said load.

Specifically, the present hoist provides that each length of the rope passes through a respective seat of said separator element.

Advantageously, all rope lengths are housed in a respective seat. Therefore, the presence of the separator element and, preferably, the movement of said separator element between the first and second elements, allows to identify any tangles between the rope lengths or the insertion of a loose rope end. If not identified and correctly resolved, such situations may lead to malfunctions of the hoist and expose the load to be moved to risks to its safety, e.g. to the risk of free fall.

Typically, one of said first and second elements is fastened, e.g. by means of a karabiner or other connector, to an anchorage point and is therefore substantially stationary, i.e. it does not translate in space. The other of said first and second elements is connected, e.g. still by means of a karabiner or other connector, to the load to be moved and therefore, depending on the forces to which it is subjected, it may translate together with the aforesaid load.

Preferably, said first element and/or said second element comprise a coupling portion. This coupling portion is configured to cooperate with the connecting means of the separator element to make a preferably reversible coupling between said first/second element and the separator element. Advantageously, the coupling between the separator element and the first/second element allows to keep the separator element in position during the actual use of the hoist in the operations of moving a load and thus correctly keeping in place the rope branches in the pulleys of the first/second element to which the separator element is connected, i.e. it avoids that the separator element can slide along said rope branches when a verification of the correct configuration of the hoist is not desired.

In an embodiment comprising a separator element with at least four seats, the first element comprises two first pulleys and said second element comprises two second pulleys. In this embodiment, the rope defines, by passing through said first and second pulleys, four lengths, each passing through a respective seat of said separator element.

Preferably, at least one of said first element and said second element comprises a locking element adapted to selectively prevent said rope from sliding. Typically, said locking element is configured as a movable element, usually a toothed cam, adapted to throttle the rope within a passage formed in said first or second element of the hoist. Specifically, said locking element is configured to prevent the rope from sliding when no tension is applied to the free end of the same rope coming out of the hoist. Advantageously, the locking element therefore prevents the movements of the load in the absence of tension on the free end of the rope. In particular, in operations of controlled lifting or lowering of a load, the locking element prevents the movement, i.e. the free fall, of the load when said free end is not tensioned by a user.

According to a further aspect of the present invention, the hoist comprises at least one protection element. Said protection element is connected to said first element and/or said second element and extends at least partially in a gap between said first and second elements. In particular, the protection element is configured to contain therein at least part of said rope lengths, separating them from the free end. According to an embodiment, said protection element is a flexible element, e.g. made of technical fabric and typically bag- or spat-shaped. According to other embodiments, said protection element may be a rigid or semi-rigid element, made e.g. of plastic material.

Advantageously, the presence of the protection element, particularly when the hoist is gathered up and contained therein for transport or placed in a bag/backpack, keeps the different rope lengths separated, thus minimising the possibility of entanglement between the same rope lengths and with the first and second pulleys, therefore preventing possible malfunctions caused by wrong arrangement of the hoist once it has been extracted from the protection element and put into use.

Another object of the present invention is a method for verifying a correct configuration of the hoist set up as described above.

According to an aspect, the verification method comprises a step of identifying the wrong positioning of said lengths and/or the insertion of said free end between said lengths by means of the separator element. In fact, the presence of the separator element, which is interposed (either in a fixed way or in a movable way) between said first element and said second element of the hoist, or made in one piece between said first element and said second element of the hoist, allows to identify possible errors of the path of the rope lengths which are passing through the seats of the separator element.

In fact, the passage of the rope length into the corresponding seat of the separator element allows the user to easily identify and follow the path of each length and to identify any undesired positions with respect to the pre-set path that is manifested by the rope length coming out of the corresponding seat of the separator element.

According to an aspect, as described in more detail below, the method provides a step of sliding said separator element along said rope lengths at least once in a direction from said first element to said second element and/or vice versa. In fact, in the event that the separator element does not slide completely (or slides obstructed), it will be possible to identify the wrong positioning of said lengths and/or the insertion of said free end between said lengths.

Following the step of identifying the wrong positioning of said lengths and/or the insertion of said free end between said lengths (possibly performed by sliding the separator element), the method comprises a step of restoring the correct positioning of said rope lengths and/or extracting said free end, without necessarily having to pull out the rope from the hoist and having to reset it with the correct passages, in order to have to eliminate a possible entanglement, thanks to highlighting the erroneously arranged rope branches pointed up by the separator element which, with its own seats, identifies the desired paths of the rope lengths, and possibly pointed up by the sliding of the separator element. Advantageously, performing said steps allows the hoist to be brought into the correct configuration and ensures proper use of the same hoist without risks to the safety of the load to be moved.

As mentioned, according to an aspect, this verification method provides a step of sliding said separator element along said rope lengths at least once in a direction from said first element to said second element and/or vice versa. This step provides that the separator element is translated one or more times along the rope lengths defined between said first element and said second element. If the sliding of the element is completed without hindrance, then the hoist is set up correctly and there are no risks of malfunction related to entanglements or tangles. If the sliding is hindered or cannot be completed, this is indicative of wrong configuration of the hoist, of tangles between the rope lengths and/or the insertion of a loose rope end between said lengths of the hoist, or between one or more rope lengths which may have wrapped around said first or second element.

Preferably, in the embodiments in which the separator element comprises connecting means adapted to cooperate with said first and/or second elements, the verification method comprises a preliminary step of decoupling said separator element and said first/second element and a final step of coupling said separator element and said first/second element. Advantageously, the separator element is freely movable between said first and second elements only during the execution of the verification method. During the normal use of the hoist, on the other hand, the separator element remains connected to one of said first and second elements and does not interfere with the same hoist, sliding along the respective rope lengths.

### BRIEF DESCRIPTION OF THE FIGURES

Further aspects and advantages of the present invention will become clearer from the following description given by way of example with reference to the accompanying schematic drawings, wherein:

FIGS. 1A-E depict five different views of the separator element of ropes according to the present invention in a possible embodiment;

FIG. 2 depicts a first embodiment of the hoist, which is subject matter of the present invention too, comprising the separator element of the ropes of FIG. 1;

FIG. 3 depicts a detail of the hoist of FIG. 2;

FIG. 4 depicts a sectional view according to the A-A plane of the hoist detail of FIG. 3;

FIG. 5 depicts a second embodiment of the hoist in accordance with the present invention.

### DESCRIPTION OF SOME EMBODIMENTS

With reference to the accompanying figures, a separator element particularly adapted to be used in a hoist 100, whether it is a simple hoist or a reduction gear hoist, has been denoted by reference 1. As will become clearer below, said separator element 1 is configured to be interposed between a first element 2 and a second element 3 of said hoist 100 or to be made in one piece with said first element 2 and/or said second element 3.

In the depicted embodiment, the separator element 1 is configured to be movably interposed between said first element 2 and second element 3. Specifically, the separator element 1 is movable along a direction (or straight line) joining said first element 2 and second element 3 when the hoist 100 is subjected to tension due, e.g., to the presence of a load or the tensioning of the rope housed in the same hoist.

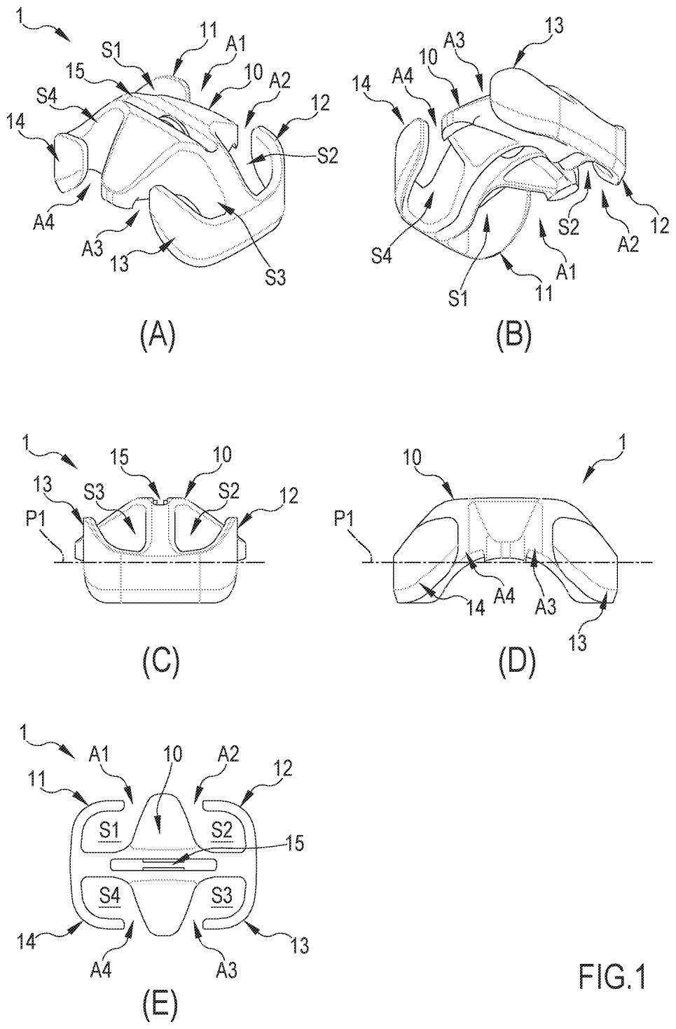

FIGS. 1A-1E depict, by way of non-limiting example, an embodiment of the separator element 1 in accordance with the present invention.

As depicted in the attached figures, the separator element 1 comprises a main body 10, i.e. a portion constituting the main part of said separator element 1.

As can be appreciated in particular from FIG. 1E, the separator element 1 comprises at least two seats S1, S2, S3, S4, preferably at least partially defined by said main body 10. In the embodiment depicted, the separator element 1 comprises four seats S1, S2, S3, S4 arranged substantially at the four vertices of the extension of the separator element 1 in an extension plane P1.

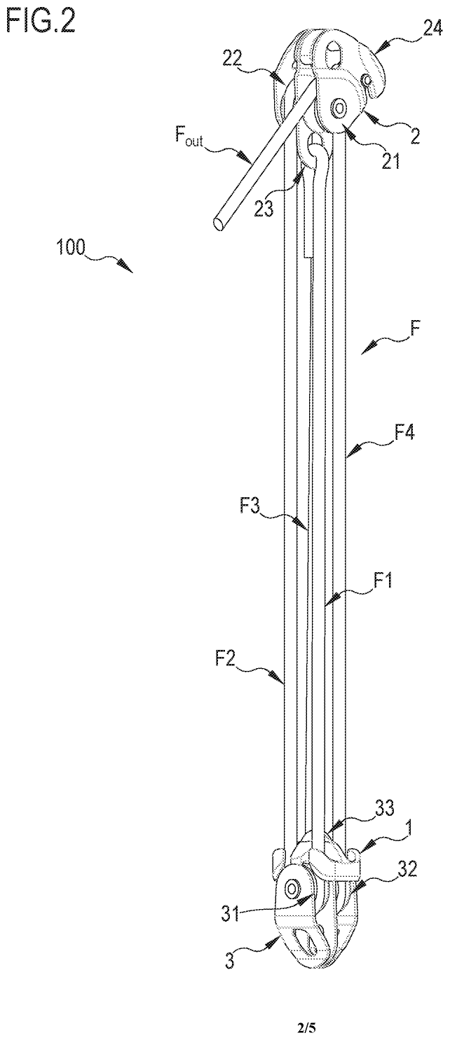

As depicted in FIGS. 2-5, said four seats S1, S2, S3, S4 are configured to allow the passage of as many lengths F1, F2, F3, F4 of a rope F of said hoist 100 through the same separator element 1. Said seats S1, S2, S3, S4 are cavities whose contours at least partially coincide with said main body 10 and which pass through said separator element 1, by putting two substantially opposite sides of the same separator element 1 in communication. For example, in the perspective of FIGS. 1C and 1D, the seats S1, S2, S3, S4 are configured to put the space above the separator element 1 in communication with the space below the same separator element.

As depicted in FIGS. 2-5, said seats S1, S2, S3, S4 extend through said separator element 1 in a rectilinear direction which is substantially parallel to or coinciding with the extension direction of the lengths F1, F2, F3, F4 of the rope F when the hoist 100 is subjected to tension, e.g. when it is connected to a load to be moved or said rope is tensioned by a user.

As mentioned, an extension plane, which coincides with a plane orthogonal to a straight line joining the first element 2 and the second element 3 of the hoist, can be identified in the separator element. In other words, the extension plane coincides with the plane orthogonal to the orientation of the lengths F1, F2, F3, F4 of the rope F of the hoist when the latter is subjected to tension given by the load and/or tensioning of the free end.

According to an aspect, as e.g. in the embodiment of FIGS. 1A-1E, the separator element 1 has a predominantly flat extension along an extension plane P1. This extension plane P1 coincides with the plane of FIGS. 1E and 1s orthogonal to the direction in which the lengths F1, F2, F3, F4 of the rope F of the hoist 100 pass through the separator element 1.

As mentioned above, different embodiments of the separator element than those depicted in the figures are however included in the scope of protection, e.g. wherein the separator element has predominant extension in height (i.e. in the direction that joins the first and second hoist elements, in use) and, therefore, not necessarily a predominant flat extension.

Even in the event of extension in height of the separator element 1, an extension plane P1 coinciding with a plane orthogonal to a straight line joining the first element 2 and the second element 3 of the hoist, i.e. coinciding with the plane orthogonal to the orientation of the lengths F1, F2, F3, F4 of the rope F of the hoist, when the latter is subjected to tension given by the load and/or tensioning of the free end, can be still identified.

According to a possible embodiment, such as e.g. depicted in the accompanying figures, said seats S1, S2, S3, S4 extend on said extension plane P1 and are configured for a passage of said lengths F1, F2, F3, F4 of the rope F in a direction substantially perpendicular to said extension plane P1.

As depicted for example in the accompanying figures, said seats S1, S2, S3, S4 put in communication sides of the separator element 1 opposite with respect to said extension plane P1 and allow the lengths F1, F2, F3, F4 of the rope F to pass through the separator element 1 in a direction substantially perpendicular to its extension plane P1.

Conveniently, said seats S1, S2, S3, S4 have, along said extension plane P1, an extension greater than the section of the rope F along the same plane, preferably higher than 125% of the section of the rope F (i.e. the length of the rope F occupies at most ⅘ of the extension of the respective seat in the extension plane P1).

In the embodiment depicted, said seats S1, S2, S3, S4 have an open section, specifically they have an open section in said extension plane P1. In other words, in this embodiment said seats are not configured as through holes but as concavities or bends formed in said separator element 1.

As shown in FIGS. 1A-1D and more clearly in FIG. 1E, the separator element 1 comprises a plurality of branches 11, 12, 13, 14 extending from said main body 10 and defining, together with said main body 10, said seats S1, S2, S3, S4. In the depicted embodiment, the separator element 1 comprises four branches 11, 12, 13, 14 which extend from said main body 10 and lie on said extension plane P1.

Specifically, each branch 11, 12, 13, 14 is connected to said main body 10 at one end and has the other end free. Said free end defines, with said main body 10, an opening A1, A2, A3, A4 in said seat S1, S2, S3, S4. Each of said openings A1, A2, A3, A4 put the respective seat S1, S2, S3, S4 in communication with the space outside said separator element 1 also along said extension plane P1. Advantageously, each opening A1, A2, A3, A4 has, in said extension plane P1, a width lower than the diameter of said rope F. Preferably, said width is less than 70% of said diameter of said rope F in order to prevent the length F1, F2, F3, F4 of the rope F, housed in the respective seat S1, S2, S3, S4, from accidentally slipping out.

Preferably, said branches 11, 12, 13, 14 may be temporarily and/or partially deformable, preferably elastically deformable, to allow the insertion of the length of the rope F into the respective seat S1, S2, S3, S4. In other words, the free end of the branches 11, 12, 13, 14 is temporarily deformable, e.g. manually by the user, to allow a length F1, F2, F3, F4 of the rope F to enter the seat S1, S2, S3, S4.

Still preferably, said branches 11, 12, 13, 14 are shaped in such a way as to facilitate the insertion of the lengths F1, F2, F3, F4 of the rope F into the seats S1, S2, S3, S4 (e.g. by temporarily crushing the rope) and then to prevent it from undesirably slipping out during the operation. In the embodiment depicted, as better shown in FIG. 1D, the free end of the branch 11, 12, 13, 14 is curved and tapered to define a pilot portion for the insertion of a respective length F1, F2, F3, F4 of the rope F, which can be inserted into the corresponding seat S1, S2, S3, S4 by pressing it against the branch in the direction of the curvature. In use, i.e. when the lengths F1, F2, F3, F4 are tensioned, they pass through the separator element in a direction orthogonal to the extension plane P1 and the slipping out of the same rope length is hindered.

According to an embodiment not depicted, the seats comprised in said separator element 1 have closed length and therefore define through holes in said main body 10 which put opposite sides of said separator element 1 in communication. Advantageously, the presence of through holes in said main body 10 prevents the rope lengths housed therein from slipping out.

According to a possible embodiment, as e.g. depicted in the accompanying figures, said separator element 1 comprises connecting means 15 for preferably reversibly coupling said separator element 1 to one of said first element 2 and said second element 3 of said hoist 10. Preferably, as shown e.g. in FIG. 1A, said connecting means 15 are positioned at said main body 10.

Depending on the embodiment, said communication means are configured to allow a type of reversible coupling to be chosen from the following: interference, interlocking, shape, snap or other equivalent couplings known in the art.

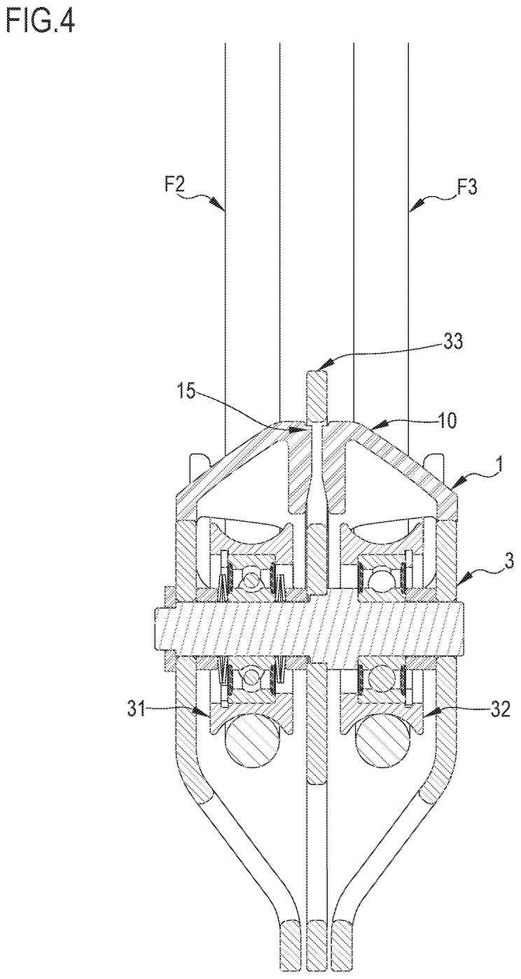

As shown in FIG. 4, in the embodiment of the accompanying figures, said connecting means 15 comprise a slot. Said slot is configured to at least partially accommodate one of said first element 2 and second element 3 of said hoist 100. Specifically, the slot is configured to make a reversible coupling by interference of parts with said first element 2 or second element 3 which, once at least partially inserted into said slot, remain firmly connected to the separator element 1. This coupling can only be released by a user who applies a sufficient force to extract the portion of the first element 2 or second element 3, which portion is inserted into the aforesaid slot.

As previously mentioned, the separator element 1 is adapted to be used in both hoists of the simple type and reduction gear hoists. FIGS. 2-5 depict, by way of non-limiting example, the use of the separator element of FIGS. 1A-1E in the context of a hoist in a 4:1 configuration. This hoist 100 is a hoist for moving a load, comprising the following elements:
a first element 2 comprising two first pulleys 21, 22;
a second element 3 comprising two second pulleys 31, 32;
the separator element 1 of FIGS. 1A-1E described above, preferably movably interposed between said first element 2 and second element 3;
a rope F, constrained at one end to the first element 2, passing through said first and second pulleys to define a length F1, F2, F3, F4 at each passage between said first element 2 and second element 3; said rope F further comprises a free end Fout coming out of said first element 2 and configured to be operated by a user for moving said load.

As depicted, each length F1, F2, F3, F4 of the rope F is passing through a respective seat S1, S2, S3, S4 of said separator element 1. With reference to FIG. 2, the rope F is, in the order, constrained to the first element 2, reaches said second element 3 and defines the first length F1 passing through the first seat S1, passes around the second pulley 31, reaches said first element 2 and defines the second length F2 passing through the second seat S2, passes around the first pulley 22, returns to said second element 3 and defines the third length F3 passing through the third seat S3, passes around the second pulley 32, returns to said first element 2 and defines the fourth length F4 passing through the fourth seat S4, passes around the further pulley 21 of the first element 2 and comes out with the free end Fout.

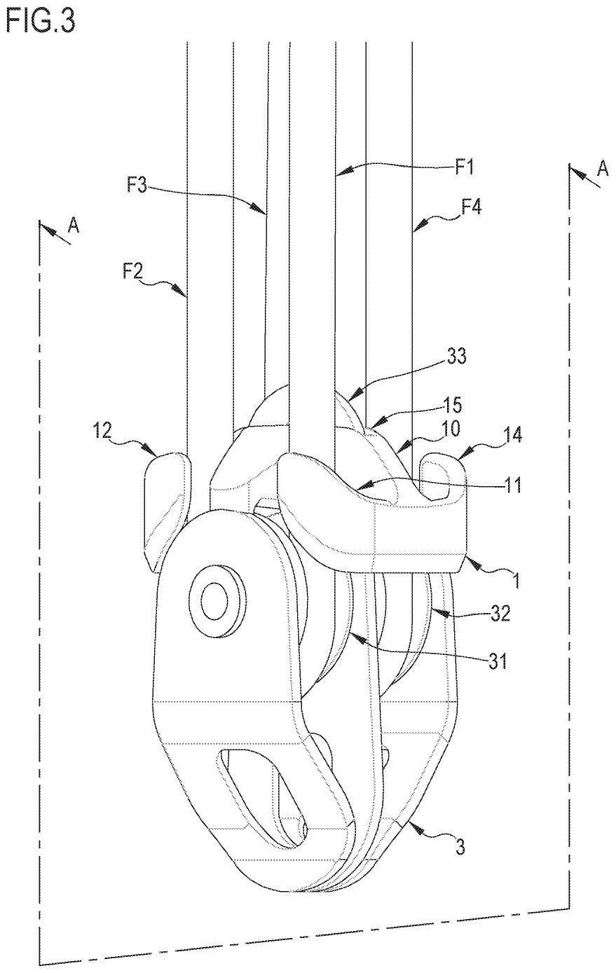

As depicted in FIGS. 2-5, said first element 2 and said second element 3 comprise a coupling portion. In the detail of FIGS. 3 and 4, the coupling portion 33 of the second element 3 is depicted. As shown, this coupling portion 33 is configured to cooperate with the connecting means 15 of the separator element 1 to make a reversible coupling, preferably by interference of parts, between said second element 3 and the separator element 1. As depicted in the attached figures, the coupling portion 33 is a portion jutting from said first element 2 and second element 3 which, in addition to being able to cooperate with the connecting means 15 of the separator element 1 (see the coupling between said second element 3 and the separator element 1 in FIG. 4), can act as a constraint point for the rope F (see the constraint of the rope F to the first element 2 in FIG. 2).

As depicted in FIG. 2, the first element 2 comprises a locking element 24 adapted to selectively prevent the sliding of said rope F. Typically, said locking element 24 is configured as a movable element adapted to throttle the rope F within a passage formed in said first element 2. Specifically, said locking element 24 is configured to prevent the rope F from sliding when no tension is applied to the free end Fout of the same rope. Thereby, the locking element 24 prevents the movements of the load in the absence of tension on the free end Fout of the rope F. In particular, in lifting operations or controlled lowering operations of a load, the locking element 24 prevents the movement, i.e. the free fall, of the load when said free end Fout is not tensioned by a user.

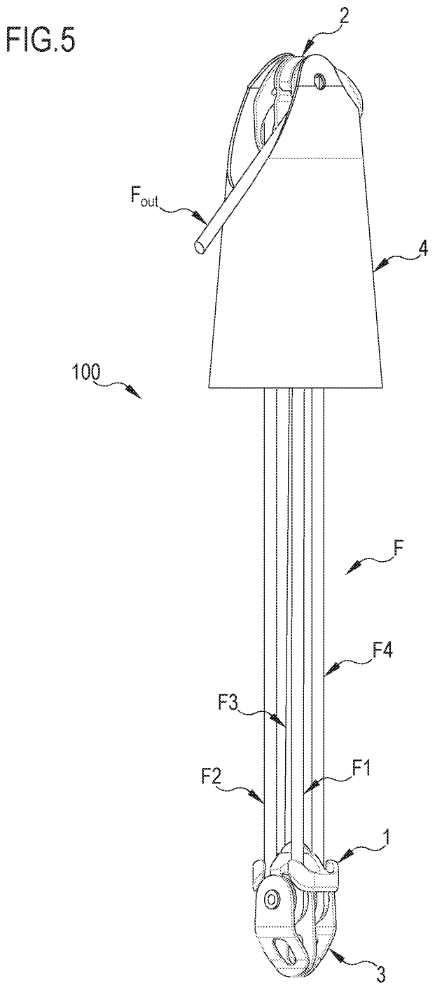

In the embodiment of FIG. 5, the hoist 100 comprises at least one protection element 4. In the depicted embodiment, said connection element 4 is connected to said first element 2 and extends at least partially in a gap between said first element 2 and said second element 3. In particular, the protection element 4 is configured to contain therein said lengths F1, F2, F3, F4 of the rope F, by separating them from the free end Fout and especially acting as packaging during the transport operations of the same hoist, e.g. when it is put away in a bag or backpack together with other equipment that could further tangle and become entangled with the hoist. According to an embodiment, said protection element 4 is a flexible element, e.g. made of technical fabric and bag- or spat-shaped. According to other embodiments, said protection element 4 is a rigid element, e.g. made of plastic material.

During a possible mode of use in the context of a hoist 100, such as the one depicted in FIGS. 2-5, the separator element 1 can be temporarily decoupled from the first/second element and can therefore be moved and slid along the lengths F1, F2, F3, F4 of the rope F.

If the sliding of the separator element 1 is completed without hindrance, then the hoist 100 is set up correctly and there are no risks of malfunction connected to entanglements or tangles. If the sliding is hindered or cannot be completed, this is indicative of a wrong configuration of the hoist 100, of tangles between the lengths F1, F2, F3, F4 of the rope F and/or the insertion of a loose rope end, e.g. the free end Fout, between said lengths F1, F2, F3, F4 of the hoist 100, or at least one of the lengths F1, F2, F3, F4 of the rope F has wrapped and included in its own path the first element 2 and/or the second element 3. Following the detection of the problem with the configuration of the hoist, a user can resolve it by restoring the correct setting, without necessarily having to correctly pull out and reposition the entire rope path but merely limiting oneself to unwinding only the path anomalies from the tangle that the separator 1 will highlight by sliding along the rope lengths. Conveniently, once the verification has been completed, the separator element 1 is coupled again to one of said first element 2 or second element 3, so as to be kept stable and stationary during the use of the hoist 100 in the load moving manoeuvres and, therefore, carrying out its function of keeping the rope lengths, which engage the sheaves of the element to which the separator is coupled, separate and in the correct seat.

1. Separator element (1) adapted to be used in a hoist (100) and configured to be interposed between a first element (2) and a second element (3) of said hoist (100) or to be made in one piece with said first element (2) and/or said second element (3), said separator element (1) comprising a main body (10) and at least two seats (S1, S2, S3, S4) for the passage of as many lengths (F1, F2, F3, F4) of a rope (F) of said hoist (100) through said separator element (1).

2. Separator element (1) according to claim 1, movably interposed between said first element (2) and/or said second element (3) of said hoist (100).

3. Separator element (1) according to claim 1 or 2, wherein said at least two seats (S1, S2, S3, S4) are configured for a passage of said lengths (F1, F2, F3, F4) of rope (F) through said separator element (1), preferably by placing two substantially opposite sides of the separator element (1) in communication.

4. Separator element (1) according to any one of the preceding claims, wherein said at least two seats (S1, S2, S3, S4) have an open section.

5. Separator element (1) according to claim 4, comprising a plurality of branches (11, 12, 13, 14) defining said at least two seats (S1, S2, S3, S4) with said main body (10), wherein each branch of said plurality of branches (11, 12, 13, 14) is connected to said main body (10) and has a free end, said free end defining with said main body (10) an opening (A1, A2, A3, A4) having a width lower than the diameter of said rope (F), said width being preferably less than 70% of said diameter of said rope (F).

6. Separator element (1) according to claim 5, wherein said branch (11, 12, 13, 14) defining said at least two seats (S1, S2, S3, S4) with said main body (10) is temporarily and/or partially deformable, preferably elastically deformable, to allow the insertion of the rope length into the seat.

7. Separator element (1) according to claim 4 or 5, wherein the end of said branch (11, 12, 13, 14) is temporarily deformable, preferably manually by the user, to allow the rope to enter the seat.

8. Separator element (1) according to any one of claims 1 to 3, wherein said at least two seats (S1, S2, S3, S4) have closed section and preferably define through holes in said main body (10).

9. Separator element (1) according to any one of the preceding claims, comprising connecting means (15) for reversibly coupling said separator element (1) to one of said first element (2) and second element (3) of said hoist (100).

10. Separator element (1) according to the preceding claim, wherein said connecting means (15) comprise a slot configured to accommodate at least partially one of said first element (2) and second element (3) of said hoist (100) and to make a reversible coupling with said first element (2) or second element (3).

11. Separator element (1) according to any one of the preceding claims, comprising four seats (S1, S2, S3, S4) for the passage of four lengths (F1, F2, F3, F4) of said rope (F) of the hoist (100).

12. Hoist (100) for moving a load, comprising:
a first element (2) comprising at least one first pulley (21, 22);
a second element (3) comprising at least one second pulley (31, 32);
the separator element (1) according to any one of the preceding claims, said separator element being interposed between said first element (2) and said second element (3) or being made in one piece with said first element (2) and/or said second element (3);
a rope (F), constrained at one end to said first element (2) or said second element (3), passing through said at least one first pulley (21, 22) and at least one second pulley (31, 32) and defining a length (F1, F2, F3, F4) at each passage between said first element (2) and second element (3), said rope (F) comprising a free end (Fout) coming out of said first element (2) or second element (3), which is configured to be operated by a user for moving said load;
wherein each length (F1, F2, F3, F4) of the rope (F) passes through a respective seat (S1, S2, S3, S4) of said separator element (1).

13. Hoist (100) according to claim 12 and claim 9, wherein said first element (2) and/or said second element (3) comprise a coupling portion (23, 33) adapted to cooperate with said connecting means (15) to make a preferably reversible coupling with said separator element (1).

14. Hoist (100) according to claim 12 or 13 and claim 11, wherein said first element (2) comprises two first pulleys (21, 22), said second element (3) comprises two second pulleys (31, 32) and said rope (F) defines, passing through said first and second pulleys, four lengths (F1, F2, F3, F4) each passing through a respective seat (S1, S2, S3, S4) of said separator element (1).

15. Hoist (100) according to any one of claims 12 to 14, wherein at least one of said first element (2) and said second element (3) comprises a locking element (24) for selectively preventing the sliding of said rope (F).

16. Hoist (100) according to any one of claims 12 to 15, comprising at least one protection element (4) connected to said first element (2) and/or said second element (3), said at least one protection element (4) extending at least partially in a gap between said first element (2) and second element (3) to contain therein at least part of said lengths (F1, F2, F3, F4) of the rope (F) and/or the element (2, 3) to which the separator element (1) is coupled.

17. Method of verifying a correct configuration of the hoist (100) according to any one of claims 12 to 16, comprising the steps of:
a) identifying the wrong positioning of said lengths (F1, F2, F3, F4) of the rope (F) and/or the insertion of said free end (Fout) between said lengths (F1, F2, F3, F4) of the rope (F);
b) restoring the correct positioning of said lengths (F1, F2, F3, F4) of the rope (F) and/or extracting said free end (Fout).

18. Verifying method according to the preceding claim, wherein said step a) comprises the step of sliding said separator element (1) along said lengths (F1, F2, F3, F4) of the rope (F) at least once in a direction from said first element (2) to said second element (3) and/or vice versa.

19. Verifying method according to claim 17 or 18 and claim 9, comprising a preliminary step of decoupling said separator element (1) and said first element (2) and/or said second element (3) and a final step of coupling said separator element (1) and said first element (2) and/or said second element (3).
